(19) United States
(12) Patent Application Publication
(10) Pub. No.: US 2025/0009580 A1
(43) Pub. Date: Jan. 9, 2025

(54) Nursing machine

(71) Applicant: SUZHOU ALTON ELECTRICAL & MECHANICAL INDUSTRY CO., LTD., Suzhou City (CN)

(72) Inventors: Weidong LU, Suzhou City (CN); Qiang SONG, Suzhou City (CN); Haibo WANG, Suzhou City (CN)

(21) Appl. No.: 18/218,024

(22) Filed: Jul. 4, 2023

(51) Int. Cl. A61G 9/00; A61G 12/00; H02J 50/10

(52) U.S. Cl. CPC A61G 9/00; A61G 12/001; H02J 50/10

(57) ABSTRACT

Disclosed is a nursing machine, including a main unit, an excrement collector, a first connecting apparatus for connecting between the main unit and the excrement collector, the first connecting apparatus includes a plug connector assembly, and at least one communicating pipe for connecting between the plug connector assembly and the main unit; the plug connector assembly includes a first coil unit for supplying power to the excrement collector, and at least one first connecting port; the excrement collector includes an excrement groove for receiving human excrement, a second coil unit corresponding to the first coil unit, and a mating interface portion; the mating interface portion includes at least one second connecting port for correspondingly butting with the at least one first connecting port; and the plug connector assembly is able to be forwardly inserted into the mating interface portion to butting with the mating interface portion.

### TECHNICAL FIELD

The disclosure relates to a nursing machine, and in particular, to a connection and power supply of an excrement collector of a nursing machine.

### BACKGROUND OF THE INVENTION

A nursing machine is mainly used for treating human excrement, the nursing machine generally includes a main unit, an excrement collector, and a connecting apparatus connected between the main unit and the excrement collector, the connecting apparatus generally includes a water delivery pipeline, an air delivery pipeline, an electric wire and the like, the main unit generally includes a negative pressure source for providing excrement suction power, the negative pressure source generally includes a motor and an impeller, and the impeller rotates under the driving of the motor to generate a negative pressure, so as to form a suction airflow; and the excrement collector is worn on the lower body of a human body, the excrement collector receives the human excrement by means of an excrement groove thereof, the excrement collector further includes an excrement and urine sensor, an angle sensor, a controller and an electrical interface, the electrical interface is exposed to be butted with the connector of the electric wire, so as to obtain electric energy, thereby being easy to rust, and in addition, the butt joint between the excrement collector and the connecting apparatus is unstable and inconvenient.

### SUMMARY OF THE INVENTION

Some embodiments of the disclosure provide a nursing machine, which achieves wireless power supply and a fast connection with an excrement collector by means of a configured plug connector assembly, thereby facilitating the use of users. The nursing machine includes a main unit, an excrement collector, and a first connecting apparatus connected between the main unit and the excrement collector, the first connecting apparatus includes a plug connector assembly and a communicating pipe, the communicating pipe is connected between the plug connector assembly and the main unit, and there is at least one communicating pipe, the plug connector assembly includes a first coil unit for supplying power to the excrement collector, and a first connecting port, and there is at least one first connecting port, the excrement collector includes an excrement groove for receiving human excrement, a second coil unit corresponding to the first coil unit, and a mating interface portion, the mating interface portion includes a second connecting port which is correspondingly butted with the at least one first connecting port, and there is at least one second connecting port, and the plug connector assembly is able to be forwardly inserted into the mating interface portion to be butted with the mating interface portion.

### BRIEF DESCRIPTION OF THE DRAWINGS

FIG. 1 is a stereogram of a main unit of a nursing machine (connected to a sewage suction hose, each communicating pipe and an electric wire);

FIG. 2 is a stereogram of a nursing machine in which a wrapping pant, an excrement collector, a sewage suction pipeline connector assembly, a plug connector assembly and the like are combined together;

FIG. 3 is a view of a separated state of an excrement collector with a sewage suction pipeline connector assembly, a plug connector assembly and the like of a nursing machine;

FIG. 4 is a stereogram of a view of an excrement collector of a nursing machine;

FIG. 5 is a stereogram of another view of an excrement collector of a nursing machine;

FIG. 6 is a stereogram of a view of a plug connector assembly of a nursing machine (connected to each communicating pipe and an electric wire);

FIG. 7 is a stereogram of another view of a plug connector assembly of a nursing machine (connected to each communicating pipe and an electric wire);

FIG. 8 is an exploded view of a plug connector assembly of a nursing machine (provided with each communicating pipe and an electric wire);

FIG. 9 is another exploded view of a plug connector assembly of a nursing machine (provided with each communicating pipe and an electric wire, and a rear cylindrical portion is not shown);

FIG. 10 is yet another exploded view of a plug connector assembly of a nursing machine (provided with each communicating pipe and an electric wire);

FIG. 11 is a vertical cross-sectional view of FIG. 2;

FIG. 12 is a partial enlarged view of FIG. 11.

The drawings include the following reference signs:
1—main unit; 10—wheels; 11—housing; 2—excrement collector; 20—excrement groove; 21—second coil unit; 210—second coil winding; 211—second backboard; 212—third side edge; 213—fourth side edge; 22—mating interface portion; 220—second connecting port; 221—second cylindrical portion; 2210—first wall; 2211—third guide groove; 2212—fourth guide groove; 2213—third blocking rib; 2214—fourth blocking rib; 2215—second wall; 2216—second locking portion; 222—second front end wall; 23—rear side wall; 24—first blocking ring; 240—first avoidance notch; 241—third avoidance notch; 25—sewage discharge interface portion; 26—second blocking ring; 260—; 261—second avoidance notch; 290—chassis portion; 291—rear seat; 3—plug connector assembly; 30—first coil unit; 300—first coil winding; 301—first backboard; 302—first side edge; 303—second side edge; 31—first connecting port; 310—air delivery connecting port; 311—water delivery connecting port; 32—first cylindrical portion; 320—first side wall; 321—first guide groove; 322—second guide groove; 323—first blocking rib; 324—second blocking rib; 325—blocking strip; 326—positioning groove; 327—protruding portion; 3270—convex corner portion; 3280—baffle; 3281—accommodating cavity; 3282—rear-end opening; 3290—second side wall; 3291—third side wall; 3292—fourth side wall; 3293—fifth side wall; 3294—accommodation groove; 33—first front end wall; 330—positioning protrusion; 34—rear cover; 340—central through opening; 341—peripheral through opening; 342—fourth avoidance notch; 343—outer peripheral wall; 35—rear cylindrical portion; 350—annular inner flange; 351—screw locking column; 36—screw; 37—circuit board unit; 370—first circuit board; 371—second circuit board; 372—third circuit board; 380—first button; 381—first locking portion; 382—extension arm; 383—reset spring; 4—communicating pipe; 40—air delivery hose; 41—water delivery hose; 50—sewage suction pipeline connector assembly; 500—second button; 51—sewage suction hose; 52—third locking portion; 53—fourth locking portion; 90—wrapping pant; 91—electric wire.

### DETAILED DESCRIPTION OF THE INVENTION

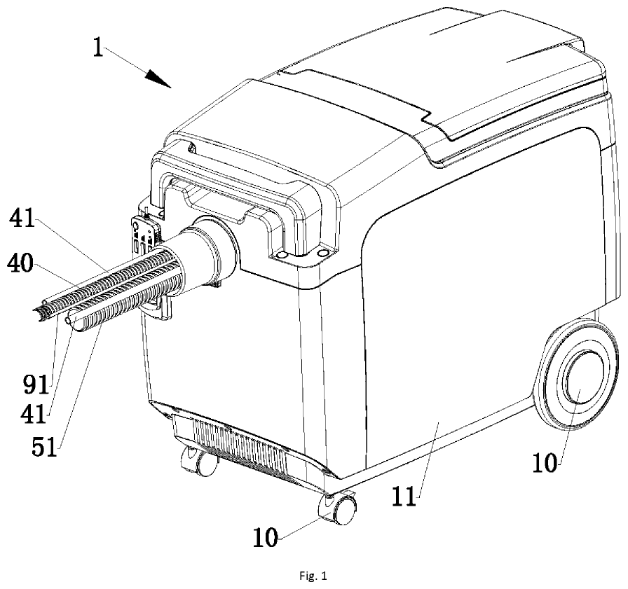

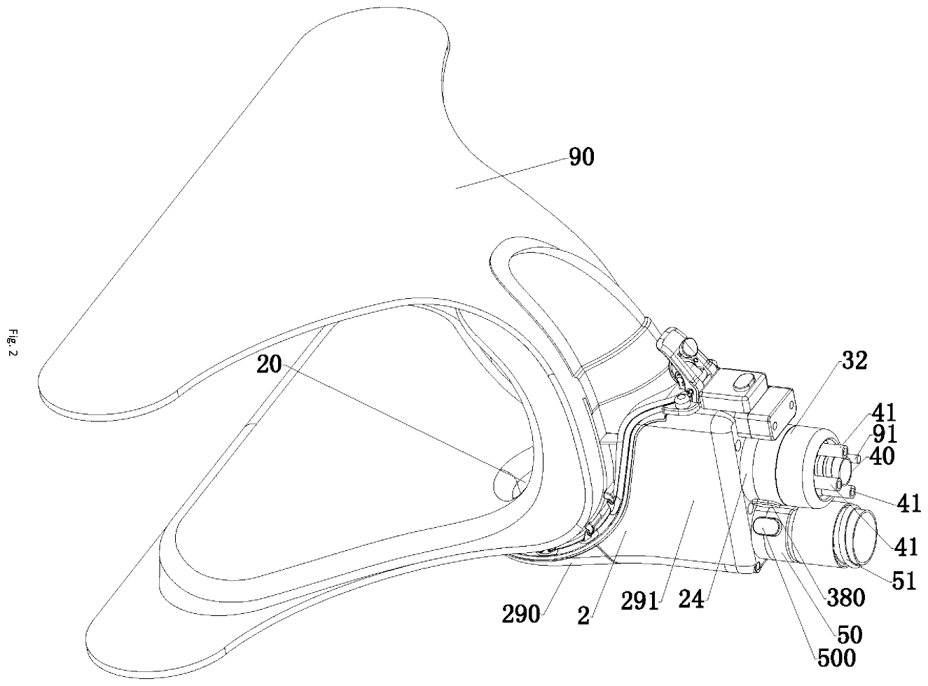

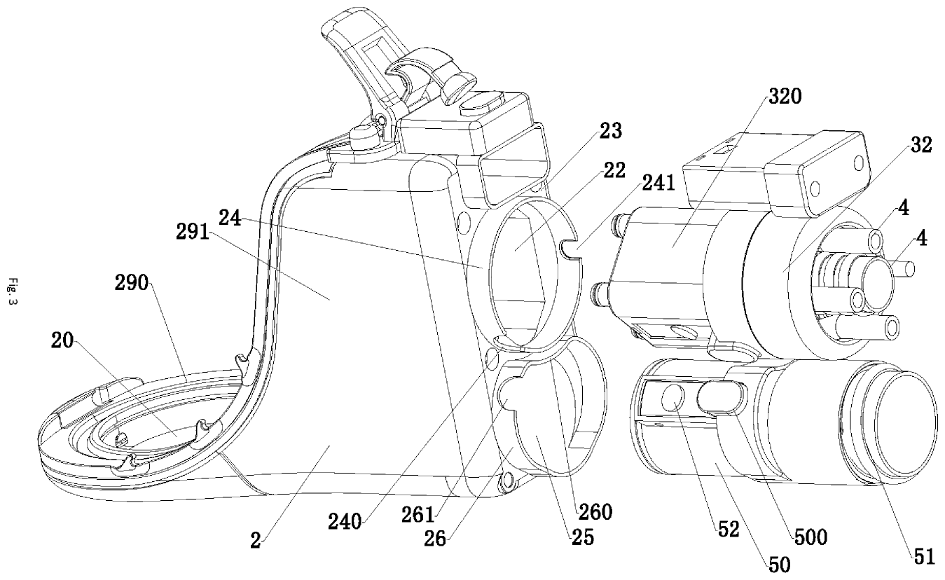

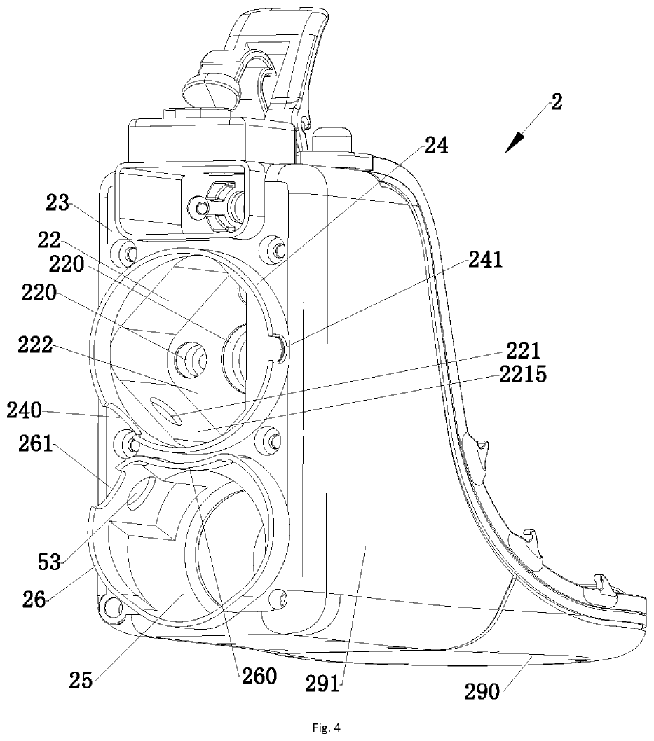

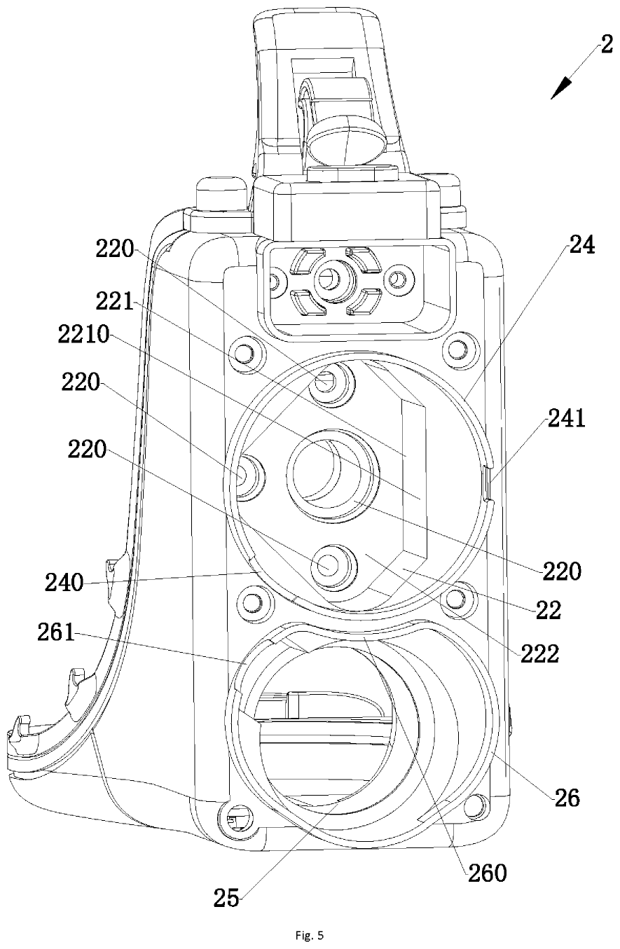

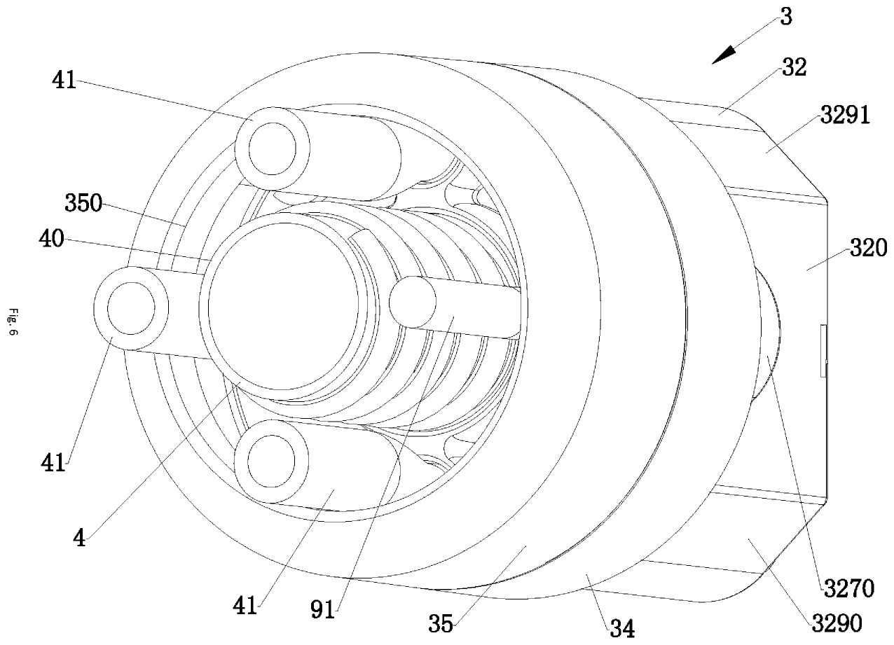

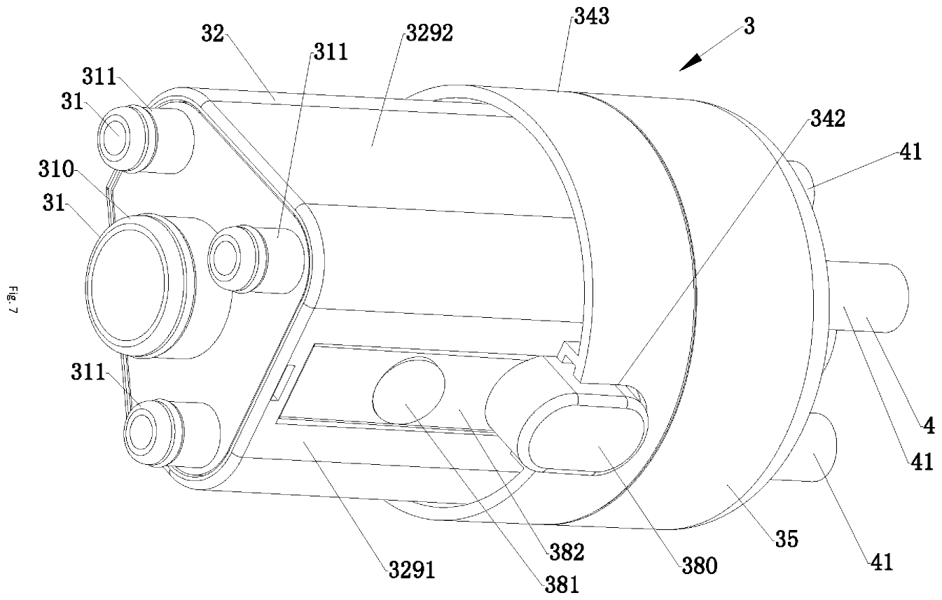

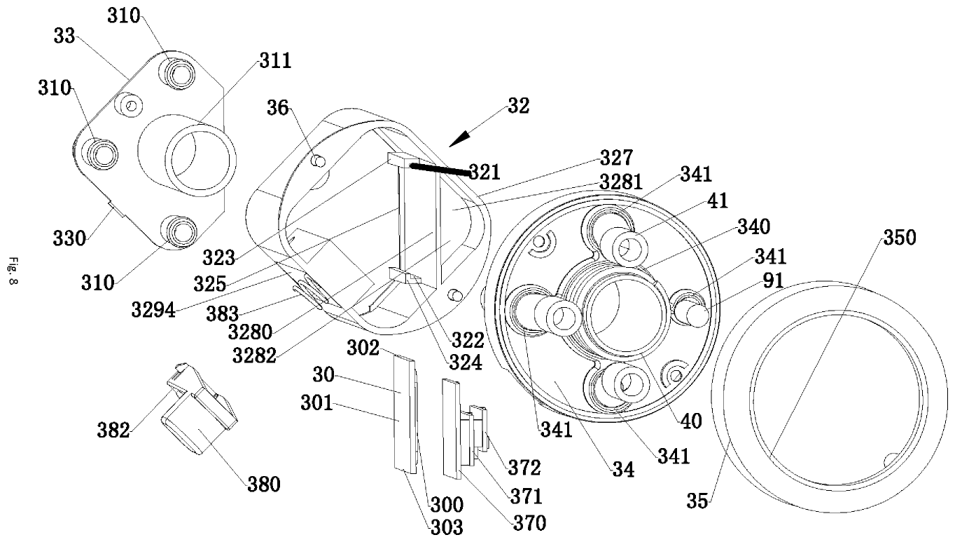

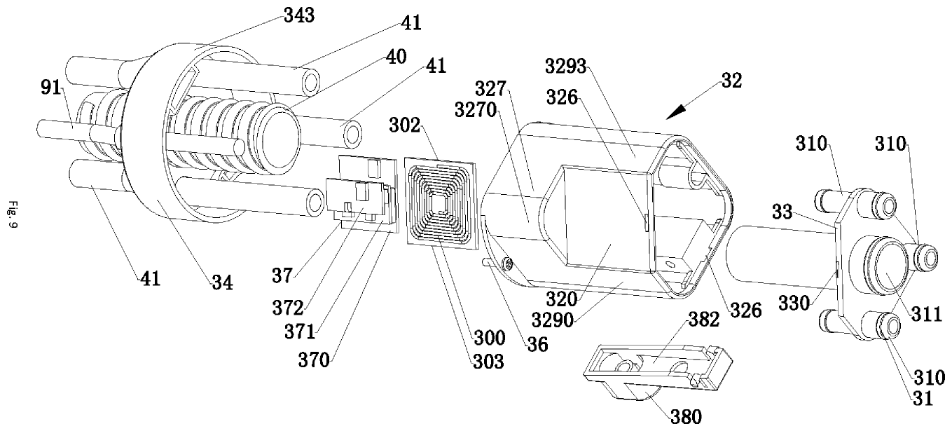

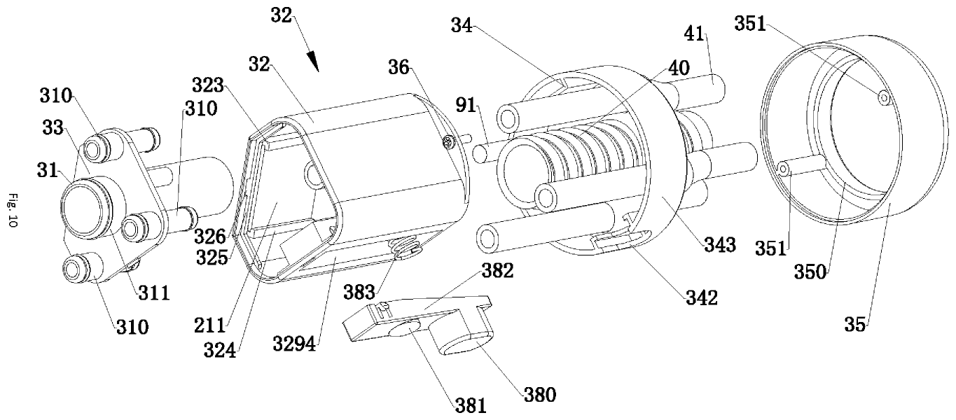

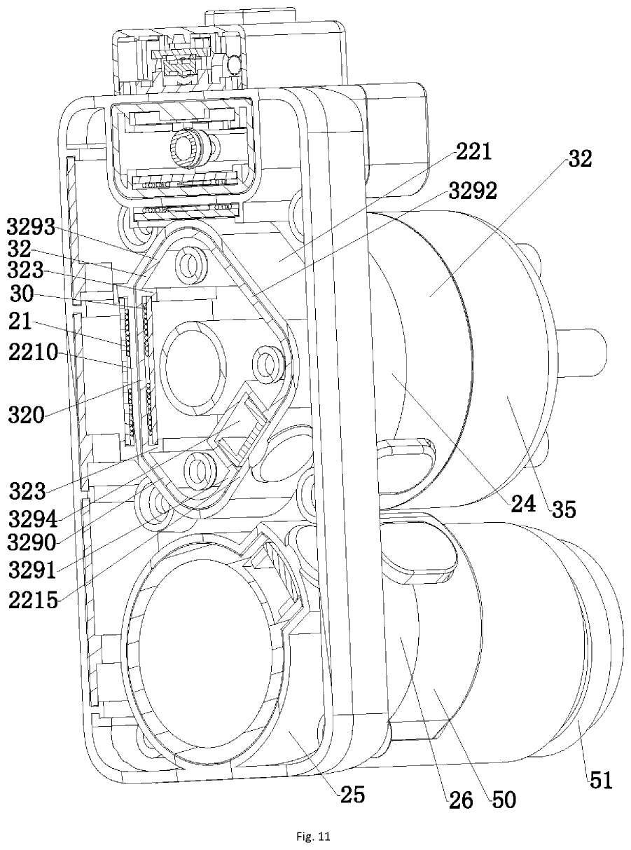

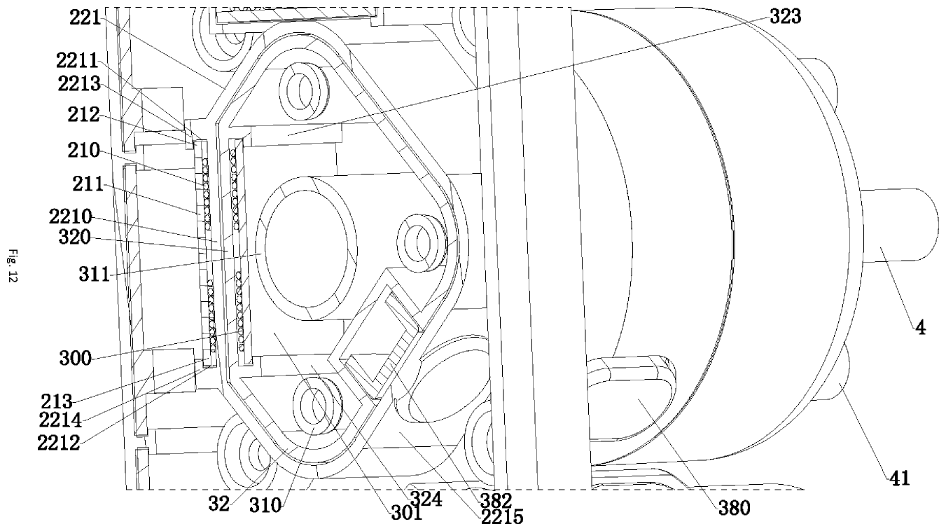

Referring to FIGS. 1-12, some embodiments of the disclosure provide a nursing machine, including a main unit 1, an excrement collector 2, a first connecting apparatus for connecting between the main unit 1 and the excrement collector 2, and a wrapping pant 90 for wearing on a human body. The first connecting apparatus includes a plug connector assembly 3 and at least one communicating pipe 4 for connecting between the plug connector assembly 3 and the main unit 1. The plug connector assembly 3 includes a first coil unit 30 which is able to be used for supplying power to the excrement collector 2, and at least one first connecting port 31. The excrement collector 2 is able to be connected to the wrapping pant 90, the excrement collector 2 is indirectly worn on the lower body of the human body by means of the wrapping pant 90, the excrement collector 2 includes an excrement groove 20 for receiving human excrement, a second coil unit 21 corresponding to the first coil unit 30, and a mating interface portion 22, the mating interface 22 includes a least one second connecting port 220 for corresponding butting with the at least one first connecting port 31, and the plug connector assembly 3 is able to be forwardly inserted into the mating interface portion 22, so as to be abutted with the mating interface portion 22. As the plug connector assembly 3 is forwardly inserted into and butted with the mating interface portion 22, the second coil unit 21 is coupled with the first coil unit 30; further, As the plug connector assembly 3 is forwardly inserted into and butted with the mating interface portion 22, the second coil unit 21 is coupled with the first coil unit 30, and the first connecting port 31 is in front-rear butt joint with the corresponding second connecting port 220; by means of such a design, the first connecting apparatus and the excrement collector 2 are quickly connected to each other by means of the plug connector assembly 3 and the mating interface portion 22, which facilitates a use of a user; and the second coil unit 21 coupled with the first coil unit 30 is able to receive a wireless power supply of the first coil unit 30. In summary, a user experience is good.

The first coil unit 30 is located inside the plug connector assembly 3, the second coil unit 21 is located inside the excrement collector 2 and is located on a periphery of the mating interface portion 22, and in a state that the plug connector assembly 3 is butted with the mating interface portion 22, the second coil unit 21 and the first coil unit 30 are spaced apart from each other in a direction intersecting with an insertion direction along which the plug connector assembly 3 is inserted into the mating interface portion 22; further, in the state that the plug connector assembly 3 is butted with the mating interface portion 22, the second coil unit 21 and the first coil unit 30 are spaced apart from each other in a direction perpendicular to a front-rear direction, thereby promoting spatial layout optimization and facilitating a miniaturization of the plug connector assembly 3; if the second coil unit 21 and the first coil unit 30 are spaced apart from each other in the front-rear direction after the plug connector assembly 3 is butted with the mating interface portion 22, the first coil unit 30 and the second coil unit 21 respectively occupy a relatively large area in a forward area perpendicular to the front-rear direction, so that a front portion of the plug connector assembly and a rear portion of the excrement collector 2 appear large, which is not conducive to product miniaturization.

The plug connector assembly 3 includes a first side wall 320, the mating interface portion 22 includes a first wall 2210, the first coil unit 30 is configured on the first side wall 320, and the second coil unit 21 is configured on the first wall 2210; in the state that the plug connector assembly 3 is butted with the mating interface portion 22, the first side wall 320 and the first wall 2210 are opposite to each other in the direction intersecting with the insertion direction along which the plug connector assembly 3 is inserted into the mating interface portion 22, and the first side wall 320 and the first wall 2210 are located between the first coil unit 30 and the second coil unit 21; and further, in the embodiment, the insertion direction along which the plug connector assembly 3 is inserted into the mating interface portion 22 is the front-rear direction, and in the state that the plug connector assembly 3 is butted with the mating interface portion 22, the first side wall 320 and the first wall 2210 are opposite to each other in the direction perpendicular to the front-rear direction. The first wall 2210 forwardly extends from a rear end of the mating interface portion 22; and the first side wall 320 abuts against the first wall 2210, the second coil unit 21 abuts against the first wall 2210, in the state that the plug connector assembly 3 is butted with the mating interface portion 22, the first side wall 320 abuts against the first wall 2210, and the first side wall 320 and the first wall 2210 are located between the first coil unit 30 and the second coil unit 21. Due to such a design, after the plug connector assembly 3 is butted with the mating interface portion 22, the first coil unit 30 and the second coil unit 21 is able to be coupled closer and more tightly. The first coil unit 30 is in a flat shape which abuts against the first side wall 320, and the second coil unit 21 is in a flat shape which abuts against the first wall 2210. The first side wall 320 and the first wall 2210 are respectively in a flat plate shape.

The at least one first connecting port 31 extends in the front-rear direction, the plug connector assembly 3 includes a first cylindrical portion 32, the first cylindrical portion 32 surrounds a rear end of the at least one first connecting port 31, and the first coil unit 30 is located inside the first cylindrical portion 32. Such a design facilitates an intensification of the plug connector assembly 3; in the state that the plug connector assembly 3 is butted with the mating interface portion 22, the first cylindrical portion 32 is at least partially inserted into the mating interface portion 22; the first side wall 320 belongs to the first cylindrical portion 32; in the state that the plug connector assembly 3 is butted with the mating interface portion 22, the first side wall 320 is at least partially inserted into the mating interface portion 22; the first coil unit 30 is located on an inner side of the first side wall 320, and the first coil unit 30 abuts against the first side wall 320. Due to such a design, after the plug connector assembly 3 is butted with the mating interface portion 22, the first coil unit 30 is closer to the first coil unit 30, thereby tighter coupling is able to be achieved. The first side wall 320 backwardly extends from a front end of the first cylindrical portion 32, and the first side wall 320 is parallel to the first connecting port 31.

The first coil unit 30 includes a first coil winding 300 and a first backboard 301, the first coil winding 300 is adhered to the first backboard 301, the first coil winding 300 is attached to the first backboard 301, the first coil winding 300 is located between the first backboard 301 and the first side wall 320, and the first coil winding 300 abuts against the first side wall 320; and the first coil winding 300 is formed by coiling an enameled wire. The first side wall 320 is parallel to the first backboard 301, and the first coil winding 300 is sandwiched between the first side wall 320 and the first backboard 301. The first cylindrical portion 32 includes a first guide groove 321 and a second guide groove 322, the first guide groove 321 and the second guide groove 322 respectively extend in the front-rear direction, the first coil unit 30, the first guide groove 321 and the second guide groove 322 are located on an inner circumference of the first cylindrical portion 32, the first coil unit 30 is positioned between the first guide groove 321 and the second guide groove 322, during installation, the first coil unit 30 is able to slide between the first guide groove 321 and the second guide groove 322 in the front-rear direction under a guidance of the first guide groove 321 and the second guide groove 322, so as to be installed between the first guide groove 321 and the second guide groove 322; and due to such a design, an installation and positioning of the first coil unit 30 are facilitated. The first cylindrical portion 32 includes a first blocking rib 323 and a second blocking rib 324, the first blocking rib 323 and the second blocking rib 324 respectively extend in the front-rear direction, a cross section of the first blocking rib 323 and a cross section of the second blocking rib 324 are respectively L-shaped, the first blocking rib 323 and the second blocking rib 324 are integrally connected to the first side wall 320 respectively, and a part of the first side wall 320 and the first blocking rib 323 enclose to form the first guide groove 321; and another part of the first side wall 320 and the second blocking rib 324 enclose to form the second guide groove 322. An inner circumference of the front end of the first cylindrical portion 32 includes a blocking strip 325, the blocking strip 325 extends in a circumferential direction of the first cylindrical portion 32, a front end of the first coil unit 30 forwardly abuts against the blocking strip 325, a front end of the first blocking rib 323 and a front end of the second blocking rib 324 are integrally connected to the blocking strip 325 respectively, a front end of the first backboard 301 forwardly abuts against the blocking strip 325, the first backboard 301 includes a first side edge 302 and a second side edge 303, which are opposite to each other, the first side edge 302 is correspondingly accommodated in the first guide groove 321, the second side edge 303 is correspondingly accommodated in the second guide groove 322, and when the first coil unit 30 is installed, the first side edge 302 and the second side edge 303 slide into the first guide groove 321 and the second guide groove 322 in the front-rear direction; and further, when the first coil unit 30 is installed, the first side edge 302 and the second side edge 303 forwardly slide into the first guide groove 321 and the second guide groove 322.

The plug connector assembly 3 includes a first front end wall 33, the first front end wall 33 is located on the front end of the first cylindrical portion 32, the at least one first connecting port 31 is arranged on the first front end wall 33, the at least one first connecting port 31 is perpendicular to the first front end wall 33, and the first coil unit 30 is located on a rear side of the first front end wall 33. In the embodiment, the first front end wall 33 is locked on the front end of the first cylindrical portion 32 by means of a screw, and the first front end wall 33 backwardly abuts against the blocking strip 325. At least a part of the at least one first connecting port 31 is integrally formed with the first front end wall 33, a front end of the first connecting port 31 is exposed in front of the first front end wall 33, the rear end of the first connecting port 31 is located behind the first front end wall 33 and is located inside the first cylindrical portion 32. The first front end wall 33 and the front end of the first cylindrical portion 32 are sealed by gluing, so as to ensure a sealing performance of the front end of the first cylindrical portion 32. The first front end wall 33 includes a positioning protrusion 330, and the front end of the first cylindrical portion 32 includes a positioning groove 326 for correspondingly accommodating the positioning protrusion 330.

The at least one communicating pipe 4 is correspondingly connected to the at least one first connecting port 31, and the rear end of the first connecting port 31 is connected to the communicating pipe 4; the at least one first connecting port 31 includes an air delivery connecting port 310 and a water delivery connecting port 311, the at least one communicating pipe 4 includes an air delivery hose 40 corresponding to the air delivery connecting port 310 and a water delivery hose 41 corresponding to the water delivery connecting port 311, the air delivery hose 40 forwardly extends into the first cylindrical portion 32 and is connected to the corresponding air delivery connecting port 310, and the water delivery hose 41 forwardly extends into the first cylindrical portion 32 and is connected to the corresponding water delivery connecting port 311. The main unit 1 includes a negative pressure source for sucking excrement, a sewage bucket for accommodating the sucked excrement, a clean water tank for water supply, a warm air blower (generally including a heater and a fan), a water pump, wheels 10 and a housing 11, the sewage bucket, the clean water tank, the warm air blower and the water pump are located in the housing 11. The excrement collector 2 further includes an internal air delivery pipeline, an air outlet facing the excrement groove, an internal water delivery pipeline and a spray head. When the excrement in the excrement groove 20 is sucked, a negative pressure is formed in the excrement groove 20 under the suction of the negative pressure source of the main unit 1, and at this time, the air is supplemented into the excrement groove 20, that is, the air flows into the excrement groove 20 from the warm air blower (the warm air blower does not work at this time), the air delivery hose 40, the air delivery connecting port 310, the second connecting port 220 correspondingly connected to the air delivery connecting port 310, the internal air delivery pipeline and the air outlet, so as to supplement the air in the excrement groove 20, so that the excrement in the excrement groove 20 is able to be sucked away more fully; and when flushing is required, water in the clean water tank flows through the water delivery hose 41, the water delivery connecting port 311, the second connecting port 220 correspondingly connected to the water delivery connecting port 311 and the internal water delivery pipeline in sequence under the suction of the water pump, and is sprayed from the spray head, so as to flush the excretion part of the human body and the excrement in the excrement groove 20; when drying is required after the flushing operation is completed, hot air of the warm air blower is able to sequentially flow through the air delivery hose 40, the air delivery connecting port 310, the second connecting port 220 correspondingly connected to the air delivery connecting port 310, and the internal air delivery pipeline, and is blown out from the air outlet, so as to dry the lower body of the human body and the interior of the excrement groove 20. The outer circumference of each first connecting port 31 includes a sealing ring for sealing with the second connecting port 220.

The first connecting apparatus further includes an electric wire 91, and the electric wire 91 is connected between the plug connector assembly 3 and the main unit 1; the plug connector assembly 3 further includes a rear cover 34, the rear cover 34 is installed on the rear end of the first cylindrical portion 32, and the at least one communicating pipe 4 and the electric wire 91 penetrate through the rear cover 34; and the at least one communicating pipe 4 and the electric wire 91 penetrate through the rear cover 34 by means of corresponding through openings. The rear cover 34 includes a central through opening 340 and a plurality of peripheral through openings 341, the central through opening 340 is located at the center of the rear cover 34, the plurality of peripheral through openings 341 are distributed on the periphery of the central through opening 340, the air delivery hose 40 passes through the rear cover 34 by means of the central through opening 340 and extends into the first cylindrical portion 32, and the water delivery hose 41 and the electric wire 91 respectively pass through the rear cover 34 by means of the plurality of corresponding peripheral through openings 341 and extend into the first cylindrical portion 32. In the embodiment, there are three water delivery hoses 41; and there are four peripheral through openings 341, which are in one-to-one correspondence with the electric wire 91 and the three water delivery hoses 41.

The plug connector assembly 3 further includes a rear cylindrical portion 35, the rear cylindrical portion 35 is located behind the rear cover 34 and is assembled with the rear cover 34, the rear cylindrical portion 35 surrounds the at least one communicating pipe 4 and the electric wire 91, the rear cylindrical portion 35 includes an annular inner flange 350 located on the inner circumference thereof, the annular inner flange 350 surrounds the at least one communicating pipe 4 and the electric wire 91, the annular inner flange 350 is similar to a hoop, and the annular inner flange 350 gathers the at least one communicating pipe 4 and the electric wire 91, so that the at least one communicating pipe 4 and the electric wire 91 are close to each other in a folding trend. The annular inner flange 350 inhibits a dispersion of the communicating pipe 4 and the electric wire 91. The first cylindrical portion 32, the rear cover 34 and the rear cylindrical portion 35 are locked together by a screw 36, and the screw 36 sequentially backwardly passes through a lock screw hole of the first cylindrical portion 32 and a lock screw hole of the rear cover 34, and are screwed on a screw locking column 351 of the rear cylindrical portion 35.

The plug connector assembly 3 further includes a circuit board unit 37, the circuit board unit 37 is electrically connected between the first coil unit 30 and the electric wire 91, and a current of the main unit 1 is delivered by the electric wire 91 to the circuit board unit 37; the first cylindrical portion 32 includes a protruding portion 327, the protruding portion 327 is located on a rear side of the first side wall 320, the protruding portion 327 protrudes relative to the first side wall 320, and the circuit board unit 37 is accommodated in the protruding portion 327. The excrement collector 2 further includes a rear side wall 23 and a first blocking ring 24, the rear side wall 23 is located on a rear side of the excrement collector 2, the rear side wall 23 is basically perpendicular to the front-rear direction, the first blocking ring 24 backwardly protrudes from the rear side wall 23, the first blocking ring 24 belongs to the mating interface portion 22 and is located on a rear of the mating interface portion 22, the plug connector assembly 3 is able to forwardly pass through the first blocking ring 24 to enter the mating interface portion 22, and the first blocking ring 24 includes a third avoidance notch 241; and the third avoidance notch 241 is configured for avoiding the protruding portion 327, and as the plug connector assembly 3 is forwardly inserted into and butted with the mating interface portion 22, a part of the protruding portion 327 forwardly enters the third avoidance notch 241. The protruding portion 327 includes a convex corner portion 3270, the convex corner portion 3270 is located on one end of the protruding portion 327, and as the plug connector assembly 3 is forwardly inserted into and butted with the mating interface portion 22, the convex corner portion 3270 forwardly enters the third avoidance notch 241. The circuit board unit 37 includes a plurality of circuit boards which are stacked together, the first cylindrical portion 32 further includes a baffle 3280, the baffle 3280 is located on the rear side of the first side wall 320, the baffle 3280 is parallel to the first side wall 320, the baffle 3280 backwardly extends from the first side wall 320, the baffle 3280 and the protruding portion 327 enclose to form an accommodating cavity 3281, the circuit board unit 37 is located in the accommodating cavity 3281, the accommodating cavity 3281 has a rear-end opening 3282 towards the rear side, and the circuit board unit 37 is placed in the accommodating cavity 3281 from the rear-end opening 3282; and the circuit board unit 37 includes the plurality of circuit boards which are stacked together, the a plurality of circuit boards are sequentially stacked in a direction perpendicular to the baffle 3280, so that a space of the accommodating cavity 3281 is able to be fully utilized to accommodate the circuit board unit 37. In the embodiment, the circuit board unit 37 includes a first circuit board 370, a second circuit board 371 and a third circuit board 372, which are stacked together. The first circuit board 370 is parallel to the baffle 3280, the areas of the first circuit board 370, the second circuit board 371 and the third circuit board 372 are sequentially reduced, and the first circuit board 370, the second circuit board 371 and the third circuit board 372 are parallel to each other. The baffle 3280 includes a through groove for enabling a connecting line between the circuit board unit 37 and the first coil unit 30 to pass through. A cross section of the accommodating cavity 3281 is approximately triangular. The electric wire 91 passes through the rear cover 34 by means of one through opening to extend into the accommodating cavity 3281 and is connected to the circuit board unit 37.

The circuit board unit 37 includes a first wireless power supply conversion circuit, and the first wireless power supply conversion circuit converts direct current into high-frequency alternating current and supplies the high-frequency alternating current to the first coil unit 30; and the excrement collector 2 includes a second wireless power supply conversion circuit, and the second wireless power supply conversion circuit is configured for converting the high-frequency alternating current which is induced by the second coil unit 21 into the direct current. In the embodiment, the electric wire 91 delivers 12V direct current, the first wireless power supply conversion circuit converts the 12V direct current into high-frequency alternating current of about 70000 Hz, and supplies the high-frequency alternating current to the first coil unit 30, the second coil unit 21 coupled with the first coil unit 30 induces electromagnetic induction to obtain the high-frequency alternating current of about 70000 Hz, and the second wireless power conversion circuit converts the high-frequency alternating current into 12V direct current (further, the 12V direct current is also able to be converted into direct current of other volt values by a voltage stabilizer, for example, 3V, 5V direct current), so as to supply the 12V direct current to electronic components of the excrement collector 2 for use, such as a urine sensor, an excrement sensor and a turn-over angle sensor. The wireless power supply conversion circuit belongs to known circuit knowledge and is able to refer to CN2018106234311, and thus details are not described again.

A plurality of corners are formed on the first cylindrical portion 32, and there are a plurality of first connecting ports 31, some of the plurality of first connecting ports 31 are correspondingly arranged at the plurality of corners on the first cylindrical portion 32, so as to fully utilize an internal space of the first cylindrical portion 32. The first cylindrical portion 32 includes a second side wall 3290, a third side wall 3291, a fourth side wall 3292 and a fifth side wall 3293, the first side wall 320, the second side wall 3290, the third side wall 3291, the fourth side wall 3292 and the fifth side wall 3293 respectively backwardly extend from a front edge of the first cylindrical portion 32; the first side wall 320 is connected to the second side wall 3290 and the fifth side wall 3293; the first side wall 320, the second side wall 3290, the third side wall 3291, the fourth side wall 3292 and the fifth side wall 3293 are connected in sequence to enclose into a cylinder; and the first side wall 320, the second side wall 3290, the third side wall 3291, the fourth side wall 3292 and the fifth side wall 3293 jointly surround the rear end of the at least one first connecting ports 31, one of the plurality of first connecting ports 31 is arranged at a corner between the second side wall 3290 and the third side wall 3291, another of the plurality of first connecting ports 31 is arranged at a corner between the third side wall 3291 and the fourth side wall 3292, and yet another of the plurality of first connecting ports 31 is arranged at a corner between the fourth side wall 3292 and the fifth side wall 3293. In a direction perpendicular to the front-rear direction, the first side wall 320 is aligned with the corner between the second side wall 3290 and the third side wall 3291, the mating interface portion 22 includes a second cylindrical portion 221, a shape of the second cylindrical portion 221 matches that of the first cylindrical portion 32, in the state that the plug connector assembly 3 is butted with the mating interface portion 22, the first side wall 320, the second side wall 3290, the third side wall 3291, the fourth side wall 3292 and the fifth side wall 3293 are respectively at least partially located in the second cylindrical portion 221 and correspondingly abut against an inner circumferential surface of the second cylindrical portion 221. Due to such a design, a rotation of the first cylindrical portion 32 relative to the second cylindrical portion 221 is able to be effectively inhibited, thereby facilitating a stable cooperation between the plug connector assembly 3 and the mating interface portion 22. In the embodiment, the cross sections of the first cylindrical portion 32 and the second cylindrical portion 221 are not circular, but shapes of formed by combining a triangle with a trapezoid, thereby effectively preventing the rotation of the first cylindrical portion 32 relative to the second cylindrical portion 221.

In the state that the plug connector assembly 3 is butted with the mating interface portion 22, the second cylindrical portion 221 surrounds the plug connector assembly 3; the second coil unit 21 is arranged on an outer circumference of the second cylindrical portion 221, so as to effectively utilize the outer circumference of the second cylindrical portion 221 to provide a sufficient location, thereby facilitating a layout of the second coil unit 21. The first coil unit 30 is arranged on the inner circumference of the first cylindrical portion 32; and the first coil unit 30 arranged on the inner circumference of the first cylindrical portion 32 and the second coil unit 21 arranged on the outer circumference of the second cylindrical portion 221 is able to be coupled more efficiently. The second cylindrical portion 221 forwardly extends from the rear side wall 23, the mating interface portion 22 further includes a second front end wall 222 corresponding to the first front end wall 33, the second front end wall 222 is located on a front end of the second cylindrical portion 221, the second connecting port 220 is configured on the second front end wall 222, the second connecting port 220 includes a through opening formed in the second front end wall 222, the second connecting port 220 forwardly extends from the second front end wall 222, in the state that the plug connector assembly 3 is butted with the mating interface portion 22, the first front end wall 33 forwardly abuts against the second front end wall 222, and the front end of the first connecting port 31 is inserted into the corresponding second connecting port 220. The first wall 2210 belongs to the second cylindrical portion 221, a front end of the first wall 2210 is connected to the second front end wall 222, a front end of the first side wall 320 is connected to the first front end wall 33, and a rear end of the first wall 2210 is connected to the rear side wall 23.

The second cylindrical portion 221 includes a third guide groove 2211 and a fourth guide groove 2212, the third guide groove 2211 and the fourth guide groove 2212 are respectively located on the outer circumference of the second cylindrical portion 221, the third guide groove 2211 and the fourth guide groove 2212 respectively extend in the front-rear direction, the second coil unit 21 is positioned between the third guide groove 2211 and the fourth guide groove 2212, the second coil unit 21 is able to backwardly slide between the third guide groove 2211 and the fourth guide groove 2212 in the front-rear direction under a guidance of the third guide groove 2211 and the fourth guide groove 2212, so that the second coil unit 21 is installed between the third guide groove 2211 and the fourth guide groove 2212. The second cylindrical portion 221 includes a third blocking rib 2213 and a fourth blocking rib 2214, the third blocking rib 2213 and the fourth blocking rib 2214 respectively extend in the front-rear direction, a cross section of the third blocking rib 2213 and a cross section of the fourth blocking rib 2214 are respectively L-shaped, the third blocking rib 2213 and the fourth blocking rib 2214 are integrally connected to the first wall 2210 respectively, a part of the first wall 2210 and the third blocking rib 2213 enclose to form the third guide groove 2211, and another part of the first wall 2210 and the fourth blocking rib 2214 enclose to form the fourth guide groove 2212. The second coil unit 21 includes a second coil winding 210 and a second backboard 211, the second coil winding 210 and the second backboard 211 are adhered together, the second coil winding 210 is attached to the second backboard 211, the second coil winding 210 is located between the second backboard 211 and the first wall 2210, the second coil winding 210 abuts against the first wall 2210, the second backboard 211 includes a third side edge 212 and a fourth side edge 213, which are opposite to each other, the third side edge 212 is correspondingly accommodated in the third guide groove 2211, the fourth side edge 213 is correspondingly accommodated in the fourth guide groove 2212, and when the second coil unit 21 is installed, the third side edge 212 and the fourth side edge 213 backwardly slide between the third guide groove 2211 and the fourth guide groove 2212 in the front-rear direction. The second coil winding 210 is formed by coiling an enameled wire. The first wall 2210 is parallel to the second backboard 211, and the second coil winding 210 is sandwiched between the first wall 2210 and the second backboard 211. A rear end of the third blocking rib 2213 and a rear end of the fourth blocking rib 2214 are connected to the rear side wall 23, the second coil unit 21 backwardly abuts against the rear side wall 23, and a rear end of the second backboard 211 backwardly abuts against the rear side wall 23. The first wall 2210 is parallel to the second connecting port 220, and the first wall 2210 is in the shape of a flat plate. In the state that the plug connector assembly 3 is butted with the mating interface portion 22, the first coil unit 30, the first side wall 320, the first wall 2210 and the second coil unit 21 are sequentially arranged in the direction intersecting with the insertion direction along which the plug connector assembly 3 is inserted into the mating interface portion 22; further, in the state that the plug connector assembly 3 is butted with the mating interface portion 22, the first backboard 301, the first coil winding 300, the first side wall 320, the first wall 2210, the second coil winding 210 and the second backboard 211 are sequentially arranged in a direction perpendicular to the front-rear direction; in the state that the plug connector assembly 3 is butted with the mating interface portion 22, the first backboard 301, the first coil winding 300, the first side wall 320, the first wall 2210, the second coil winding 210 and the second backboard 211 sequentially abut against each other in the direction perpendicular to the front-rear direction, therefore after the plug connector assembly 3 is butted with the mating interface portion 22, the distance between the first coil winding 300 and the second coil winding 210 is closer, and thus tighter coupling is able to be achieved to perform effective wireless power supply; and in the state that the plug connector assembly 3 is butted with the mating interface portion 22, the first coil unit 30 does not backwardly exceed the mating interface portion 22. The first backboard 301 and the second backboard 211 respectively have a magnetic conductivity and are able to be made of magnetic sheets respectively, so as to enhance a wireless power supply efficiency between the first coil winding 300 and the second coil winding 210.

The nursing machine further includes a second connecting apparatus for connecting between the main unit 1 and the excrement collector 2, the second connecting apparatus includes a sewage suction pipeline connector assembly 50 and a sewage suction hose 51 connected to the sewage suction pipeline connector assembly 50, the sewage suction hose 51 is connected between the sewage suction pipeline connector assembly 50 and the main unit 1, the excrement collector 2 includes a chassis portion 290 and a rear seat 291, the chassis portion 290 forwardly extends from the rear seat 291, the rear seat 291 upwardly extends to be higher than the chassis portion 290, the excrement groove 20 is concavely formed on the chassis portion 290, and the rear side wall 23 belongs to the rear seat 291. A sewage discharge interface portion 25 and the mating interface portion 22 are arranged on the rear seat 291, the sewage discharge interface portion 25 and the mating interface portion 22 forwardly recess from a rear of the rear seat 291 respectively, the sewage discharge interface portion 25 is parallel to the mating interface portion 22, the sewage discharge interface portion 25 is located below the mating interface portion 22, the sewage suction pipeline connector assembly 50 is able to be inserted into the sewage discharge interface portion 25 to be in fluid communication with the excrement groove 20, and excrement received by the excrement groove 20 under the suction of the negative pressure source flows to the main unit 1 from the sewage suction pipeline connector assembly 50 and the sewage suction hose 51, and is stored in the sewage bucket of the main unit 1. The sewage suction pipeline connector assembly 50 is independent of the plug connector assembly 3, which means that the sewage suction pipeline connector assembly 50 and the plug connector assembly 3 are two separate assemblies, regardless of whether the sewage suction pipeline connector assembly 50 is butted with the sewage discharge interface portion 25, the plug connector assembly 3 is able to be butted with the mating interface section 22, and on the contrary, regardless of whether the plug connector assembly 3 is butted with the mating interface section 22, the sewage suction pipeline connector assembly 50 is able to butted with the sewage discharge interface portion 25; and the sewage suction pipeline connector assembly 50 is in contact with the excrement for a long time, and thus needs to be periodically cleaned and disinfected, the sewage suction pipeline connector assembly 50 is independent of the plug connector assembly 3, thereby avoiding the plug connector assembly 3 being bound with the sewage suction pipeline connector assembly 50, so the sewage suction pipeline connector assembly 50 is able to be independently disinfected, thereby being more convenient, and facilitating to keep a cleanness of the plug connector assembly 3 without being polluted by the sewage suction pipeline connector assembly 50.

The excrement collector 2 further includes a second blocking ring 26, the first blocking ring 24 is located above the second blocking ring 26, the second blocking ring 26 belongs to the sewage discharge interface portion 25 and is located on a rear of the sewage discharge interface portion 25, the sewage suction pipeline connector assembly 50 is able to forwardly pass through the second blocking ring 26 to enter the sewage discharge interface portion 25, the second blocking ring 26 backwardly protrudes from the rear side wall 23, the second blocking ring 26 includes an arc-shaped avoidance portion 260 corresponding to a lower portion of the first blocking ring 24, and the arc-shaped avoidance portion 260 is formed by recessing an upper portion of the second blocking ring 26 downwards; and the arc-shaped avoidance portion 260 plays an avoidance function to avoid the lower portion of the first retaining ring 24. The plug connector assembly 3 includes a first button 380, and the first blocking ring 24 includes a first avoidance notch 240 corresponding to the first button 380; the sewage suction pipeline connector assembly 50 includes a second button 500, and the second blocking ring 26 includes a second avoidance notch 261 corresponding to the second button 500; As the plug connector assembly 3 is forwardly inserted into the mating interface portion 22, the first button 380 is forwardly embedded into the first avoidance notch 240; and as the sewage suction pipeline connector assembly 50 is forwardly inserted into the sewage discharge interface portion 25, the second button 500 is forwardly embedded into the second avoidance notch 261. The rear cover 34 includes a fourth avoidance notch 342 corresponding to the first button 380, the first button 380 is partially accommodated in the fourth avoidance notch 342, after the plug connector assembly 3 is butted with the mating interface portion 22, the first avoidance notch 240 and the fourth avoidance notch 342 enclose the first button 380, so that an integrity is better after the plug connector assembly 3 is butted with the mating interface portion 22, and a certain protection role is played on the first button 380. The rear cover 34 includes an outer peripheral wall 343, the outer peripheral wall 343 surrounds the rear end of the first cylindrical portion 32, and the fourth avoidance notch 342 is formed in the outer peripheral wall 343; and in the state that the plug connector assembly 3 is butted with the mating interface portion 22, the outer peripheral wall 343 forwardly abuts against the first blocking ring 24. The first avoidance notch 240 is located above the second avoidance notch 261, and observing from rear to front, the first avoidance notch 240 is located on a lower left side of the first blocking ring 24, and the second avoidance notch 261 is located on a top left side of the second blocking ring 26. In such a design, it means that the first button 380 embedded into the first avoidance notch 240 is located on the lower left side of the first blocking ring 24, and the second button 500 embedded into the second avoidance notch 261 is located on the top left side of the second blocking ring 26, so that the first button 380 embedded into the first avoidance notch 240 and the second button 500 embedded into the second avoidance notch 261 are located at a left side included angle location between the first blocking ring 24 and the second blocking ring 26. Therefore, a spatial layout is compact, the first button 380 and the second button 500 are also conveniently operated by the right hand of the user, and in addition, the included angle location also plays a certain shielding and protection role on the first button 380 and the second button 500, thereby reducing a probability of unlocking a lock by mistake.

The plug connector assembly 3 includes a first locking portion 381, the mating interface portion 22 includes a second locking portion 2216 for mating with the first locking portion 381, the second locking portion 2216 is located inside the mating interface portion 22, the first locking portion 381 is also located inside the mating interface portion 22 when the first locking portion 381 is in a locked state with the second locking portion 2216, the first locking portion 381 and the second locking portion 2216 are both located inside the mating interface portion 22 in the mating state, so that the two portions are protected to be touched by an external object, and thus the mating therebetween is unlikely to be removed by mistake; one of the first locking portion 381 and the second locking portion 2216 is a clamping groove, and the other one of the first locking portion 381 and the second locking portion 2216 is a buckle protrusion; the first locking portion 381 and the second locking portion 2216 are able to be buckled to achieve locking fit, so as to lock the plug connector assembly 3 and the mating interface portion 22, which are butted together; As the plug connector assembly 3 is forwardly inserted into and butted with the mating interface portion 22, the first locking portion 381 is buckled with the second locking portion 2216; the first button 380 is able to move under a pressing of a hand of the user to drive the first locking portion 381 to deviate from the second locking portion 2216, so that a locking between the plug connector assembly 3 and the mating interface portion 22 is released; and in the embodiment, the second locking portion 2216 is the clamping groove, and the first locking portion 381 is the buckle protrusion. The mating interface portion 22 includes a second wall 2215, the second wall 2215 belongs to the second cylindrical portion 221, the second locking portion 2216 is concavely arranged in a groove of the second wall 2215, the second wall 2215 corresponds to the third side wall 3291, and in the state that the plug connector assembly 3 is butted with the mating interface portion 22, the third side wall 3291 correspondingly abuts against the second wall 2215 of the second cylindrical portion 221.

The plug connector assembly 3 further includes an extension arm 382, the extension arm 382 is rotatably connected to the first cylindrical portion 32, the first cylindrical portion 32 includes an accommodation groove 3294 for accommodating the extension arm 382, the accommodation groove 3294 is formed by recessing the third side wall 3291, a front end of the extension arm 382 is rotatably connected to the two sides of the accommodation groove 3294, the first locking portion 381 and the first button 380 are respectively arranged on the extension arm 382 in a protruding manner, a reset spring 383 is included between a rear end of the extension arm 382 and a rear end of the accommodation groove 3294, and under a pressing of the reset spring 383, the rear end of the extension arm 382 is pressed on the outer peripheral wall 343 in the radial direction of the outer peripheral wall 343, so that the rear end of the extension arm 382 will not tilt up excessively. The sewage suction hose 51 includes a third locking portion 52, the sewage discharge interface portion 25 includes a fourth locking portion 53 which is able to be buckled with the third locking portion 52, and the second button 500 is able to move under the pressing of the hand of the user to drive the third locking portion 52 to deviate from the fourth locking portion 53, so as to release the locking.

1. A nursing machine, comprising a main unit, an excrement collector, a first connecting apparatus for connecting between the main unit and the excrement collector, the first connecting apparatus comprising a plug connector assembly and at least one communicating pipe for connecting between the plug connector assembly and the main unit; the plug connector assembly comprising a first coil unit for supplying power to the excrement collector and at least one first connecting port; the excrement collector comprising an excrement groove for receiving human excrement, a second coil unit corresponding to the first coil unit, and a mating interface portion; the mating interface portion comprising at least one second connecting port for correspondingly butting with the at least one first connecting port; and the plug connector assembly is able to be forwardly inserted into the mating interface portion to butting with the mating interface portion.

2. The nursing machine according to claim 1, wherein as the plug connector assembly is forwardly inserted into and butted with the mating interface portion, the second coil unit is coupled with the first coil unit, and the first connecting port is in front-rear butt joint with the corresponding second connecting port; the first coil unit is located inside the plug connector assembly, the second coil unit is located inside the excrement collector and is located on a periphery of the mating interface portion, and in a state that the plug connector assembly is butted with the mating interface portion, the second coil unit and the first coil unit are spaced apart from each other in a direction intersecting with an insertion direction along which the plug connector assembly is inserted into the mating interface portion.

3. The nursing machine according to claim 2, wherein the plug connector assembly comprises a first side wall, the mating interface portion comprises a first wall, the first coil unit is configured on the first side wall, and the second coil unit is configured on the first wall; in the state that the plug connector assembly is butted with the mating interface portion, the first side wall and the first wall are opposite to each other in the direction intersecting with the insertion direction along which the plug connector assembly is inserted into the mating interface portion, and the first side wall and the first wall are located between the first coil unit and the second coil unit.

4. The nursing machine of claim 1, wherein the plug connector assembly comprises a first side wall, the mating interface portion comprises a first wall, and the first wall forwardly extends from a rear end of the mating interface portion; the first coil unit abuts against the first side wall, and the second coil unit abuts against the first wall; in the state that the plug connector assembly is butted with the mating interface portion, the first side wall is at least partially inserted into the mating interface portion and the first side wall abuts against the first wall; in the state that the plug connector assembly is butted with the mating interface portion, the first coil unit, the first side wall, the first wall and the second coil unit are sequentially arranged in a direction intersecting with an insertion direction along which the plug connector assembly is inserted into the mating interface portion.

5. The nursing machine according to claim 1, wherein the insertion direction along which the plug connector assembly is inserted into the mating interface portion is a front-rear direction, the at least one first connecting port extends in the front-rear direction, the plug connector assembly comprises a first cylindrical portion, the first cylindrical portion surrounds a rear end of the at least one first connecting port, the first coil unit is located inside the first cylindrical portion, in the state that the plug connector assembly is butted with the mating interface portion, the second coil unit is coupled with the first coil unit and the first cylindrical portion is at least partially inserted into the mating interface portion.

6. The nursing machine according to claim 5, wherein the first cylindrical portion comprises a first guide groove and a second guide groove, the first guide groove and the second guide groove respectively extend in the front-rear direction, the first coil unit, the first guide groove and the second guide groove are located inside the first cylindrical portion, the first coil unit is positioned between the first guide groove and the second guide groove, and the first coil unit is able to slide between the first guide groove and the second guide groove in the front-rear direction under a guidance of the first guide groove and the second guide groove.

7. The nursing machine according to claim 6, wherein the first cylindrical portion further comprises a blocking strip, the blocking strip blocks a front end of the first guide groove and a front end of the second guide groove, the blocking strip is arranged on an inner circumference of a front end of the first cylindrical portion, a front end of the first coil unit forwardly abuts against the blocking strip, the plug connector assembly comprises a first front end wall, the first front end wall is installed on the front end of the first cylindrical portion, the first front end wall is located on the front end of the first cylindrical portion, the at least one first connecting port is configured on the first front end wall, the at least one first connecting port is perpendicular to the first front end wall, and the first coil unit and the blocking strip are located on a rear side of the first front end wall.

8. The nursing machine according to claim 5, wherein the first cylindrical portion comprises a first side wall, the first side wall constitutes a part of an outer peripheral wall of the plug connector assembly, and in the state that the plug connector assembly is butted with the mating interface portion, the first side wall is at least partially inserted into the mating interface portion; the first coil unit is located on an inner side of the first side wall, the first coil unit abuts against the first side wall, and the first coil unit and the first side wall are sequentially arranged in a direction intersecting with an insertion direction along which the plug connector assembly is inserted into the mating interface portion.

9. The nursing machine according to claim 8, wherein the first coil unit comprises a first coil winding and a first backboard, the first coil winding is attached to the first backboard, the first coil winding is located between the first backboard and the first side wall, and the first coil winding abuts against the first side wall; the mating interface portion comprises a first wall, and the second coil unit comprises a second coil winding and a second backboard; in the state that the plug connector assembly is butted with the mating interface portion, the first backboard, the first coil winding, the first side wall, the first wall, the second coil winding and the second backboard are sequentially arranged in a direction substantially perpendicular to the front-rear direction; the first cylindrical portion further comprises a first guide groove, a second guide groove, a blocking strip, a first blocking rib and a second blocking rib, a part of the first side wall and the first blocking rib enclose to form the first guide groove, and another part of the first side wall and the second blocking rib enclose to form the second guide groove; the blocking strip is arranged on an inner circumference of a front end of the first cylindrical portion, and a front end of the first blocking rib and a front end of the second blocking rib are integrally connected to the blocking strip respectively; and the first backboard has a magnetic conductivity, the first backboard comprises a first side edge and a second side edge opposite to each other, the first side edge is correspondingly accommodated in the first guide groove, and the second side edge is correspondingly accommodated in the second guide groove.

10. The nursing machine according to claim 5, wherein the at least one communicating pipe is correspondingly connected to the at least one first connecting port, the at least one first connecting port comprises an air delivery connecting port and a water delivery connecting port, the at least one communicating pipe comprises an air delivery hose corresponding to the air delivery connecting port and a water delivery hose corresponding to the water delivery connecting port, the air delivery hose forwardly extends into the first cylindrical portion and is connected to the corresponding air delivery connecting port, and the water delivery hose forwardly extends into the first cylindrical portion and is connected to the corresponding water delivery connecting port.

11. The nursing machine according to claim 10, wherein the first connecting apparatus further comprises an electric wire, and the electric wire is connected between the plug connector assembly and the main unit; the plug connector assembly further comprises a rear cover, the rear cover is installed on a rear end of the first cylindrical portion, and the at least one communicating pipe and the electric wire penetrate through the rear cover; the rear cover comprises a central through opening and a plurality of peripheral through openings, the central through opening is located at a center of the rear cover, the plurality of peripheral through openings are distributed on a periphery of the central through opening, the air delivery hose penetrates through the central through opening and extends into the first cylindrical portion, and the water delivery hose and the electric wire respectively penetrate through the plurality of corresponding peripheral through openings and extend into the first cylindrical portion.

12. The nursing machine according to claim 5, wherein the plug connector assembly further comprises a circuit board unit, the circuit board unit is located inside the first cylindrical portion, the first connecting apparatus further comprises an electric wire, the electric wire is connected between the main unit and the plug connector assembly, the circuit board unit is electrically connected between the first coil unit and the electric wire, the first cylindrical portion comprises a first side wall corresponding to the first coil unit, and a protruding portion, the protruding portion protrudes relative to the first side wall, and the circuit board unit is accommodated in the protruding portion.

13. The nursing machine according to claim 12, wherein the first cylindrical portion further comprises a baffle, the baffle is located inside the first cylindrical portion, the baffle and the protruding portion enclose to form an accommodating cavity, the circuit board unit is located inside the accommodating cavity, the accommodating cavity has a rear-end opening towards a rear side, and the circuit board unit is placed in the accommodating cavity from the rear-end opening; and the baffle is located on a rear side of the first side wall, and the baffle backwardly extends from the first side wall.

14. The nursing machine according to claim 5, wherein there are a plurality of first connecting ports, and some of the plurality of first connecting ports are correspondingly arranged at a plurality of corners on the first cylindrical portion; the first cylindrical portion comprises a first side wall, a second side wall, a third side wall, a fourth side wall and a fifth side wall, the first side wall, the second side wall, the third side wall, the fourth side wall and the fifth side wall respectively backwardly extend from a front edge of the first cylindrical portion, the first side wall is connected to the second side wall and the fifth side wall, the first side wall, the second side wall, the third side wall, the fourth side wall and the fifth side wall are sequentially connected to form a cylindrical shape, one of the plurality of first connecting ports is arranged at a corner between the second side wall and the third side wall, another of the plurality of first connecting ports is arranged at a corner between the third side wall and the fourth side wall, and yet another of the plurality of first connecting ports is arranged at a corner between the fourth side wall and the fifth side wall; and the mating interface portion comprises a second cylindrical portion, and in the state that the plug connector assembly is butted with the mating interface portion, the first side wall, the second side wall, the third side wall, the fourth side wall and the fifth side wall are respectively at least partially located inside the second cylindrical portion, and correspondingly abut against an inner circumferential surface of the second cylindrical portion.

15. The nursing machine according to claim 1, wherein the mating interface portion includes a second cylindrical portion, in the state that the plug connector assembly is butted with the mating interface portion, the second cylindrical portion surrounds the plug connector assembly; the second coil unit is arranged on an outer circumference of the second cylindrical portion; and the plug connector assembly further comprises a first cylindrical portion, the first coil unit is arranged on an inner circumference of the first cylindrical portion, and in the state that the plug connector assembly is butted with the mating interface portion, the first cylindrical portion is at least partially inserted into the second cylindrical portion.

16. The nursing machine according to claim 15, wherein the plug connector assembly comprises a first front end wall, the first front end wall is located on a front end of the first cylindrical portion, and the at least one first connecting port is configured on the first front end wall; the mating interface portion further comprises a second front end wall corresponding to the first front end wall, the second front end wall is located on a front end of the second cylindrical portion, and the at least one second connecting port is configured on the second front end wall; the first cylindrical portion comprises a first side wall, the second cylindrical portion comprises a first wall, the first side wall forwardly extends to the first front end wall, and the first wall forwardly extends to the second front end wall; and in the state that the plug connector assembly is butted with the mating interface portion, the first side wall and the first wall are located between the first coil unit and the second coil unit, and the first side wall is located between the first wall and the first coil unit.

17. The nursing machine according to claim 16, wherein the first side wall and the first wall are respectively in a flat plate shape, the first coil unit is in a flat shape which abuts against the first side wall, and the second coil unit is in a flat shape which abuts against the first wall; and the second cylindrical portion comprises a third guide groove and a fourth guide groove, the third guide groove and the fourth guide groove are respectively located on the outer circumference of the second cylindrical portion, the second coil unit is positioned between the third guide groove and the fourth guide groove, and the second coil unit is able to backwardly slide between the third guide groove and the fourth guide groove under a guidance of the third guide groove and the fourth guide groove.

18. The nursing machine according to claim 15, wherein the plug connector assembly comprises an extension arm, a first locking portion, and a first button; the extension arm is rotatably connected to the first cylindrical portion, the first cylindrical portion comprises an accommodating groove for accommodating the extension arm, the first locking portion and the first button are arranged on the extension arm, the matching interface portion comprises a second locking portion for mating the first locking portion, and a second wall, the second wall belongs to the second cylindrical portion, and the second locking portion is arranged on the second wall; the first locking portion is able to be buckled with the second locking portion, so as to lock the plug connector assembly and the mating interface portion together; the second locking portion is located inside the mating interface portion, and the first locking portion is also located inside the mating interface portion when the first locking portion is in a locked state with the second locking portion; as the plug connector assembly is forwardly inserted into and butted with the mating interface portion, the first locking portion is buckled with the second locking portion; and the first locking portion is able to move under pressing of a hand of a user, so as to drive the first locking portion to deviate from the second locking portion.

19. The nursing machine according to claim 1, wherein the at least one communicating pipe is correspondingly connected to the at least one first connecting port, the at least one first connecting port comprises an air delivery connecting port and a water delivery connecting port, the nursing machine further comprises a second connecting apparatus for connecting between the main unit and the excrement collector, the excrement collector comprises a chassis portion and a rear seat, the excrement groove is concavely formed on the chassis portion, the chassis portion forwardly extends from the rear seat, the rear seat upwardly extends to be higher than the chassis portion, the second connecting apparatus comprises a sewage suction pipeline connector assembly and a sewage suction hose connected to the sewage suction pipeline connector assembly, the sewage suction pipeline connector assembly is independent of the plug connector assembly, and the sewage suction hose is connected between the sewage suction pipeline connector assembly and the main unit; and the excrement collector further comprises a sewage discharge interface portion, the mating interface portion and the sewage discharge interface portion are arranged on the rear seat, the sewage discharge interface portion and the mating interface portion respectively forwardly recess from a rear of the rear seat, the sewage discharge interface portion is parallel to the mating interface portion, the sewage discharge interface portion is located below the mating interface portion, and the sewage suction pipeline connector assembly is able to be inserted into the sewage discharge interface portion to form fluid communication with the excrement groove.

20. The nursing machine according to claim 19, wherein the excrement collector further comprises a first blocking ring and a second blocking ring, the first blocking ring backwardly protrudes, the first blocking ring belongs to the mating interface portion and is located on a rear of the mating interface portion, the plug connector assembly is able to forwardly pass through the first blocking ring to enter the mating interface portion, and the first blocking ring is located above the second blocking ring; the second blocking ring backwardly protrudes, the second blocking ring belongs to the sewage discharge interface portion and is located on a rear of the sewage discharge interface portion, and the sewage suction pipeline connector assembly is able to forwardly pass through the second blocking ring to enter the sewage discharge interface portion; and the plug connector assembly further comprises a first button, the first blocking ring comprises a first avoidance notch corresponding to the first button, as the plug connector assembly is forwardly inserted into the mating interface portion, the first button is at least partially embedded into the first avoidance notch forwards.
